(19) United States
(12) Patent Application Publication
(10) Pub. No.: US 2011/0258202 A1
(43) Pub. Date: Oct. 20, 2011

(54) CONCEPT EXTRACTION USING TITLE AND EMPHASIZED TEXT

(76) Inventors: Rajyashree Mukherjee, Minlo Park, CA (US); Yongzheng Zhang, San Jose, CA (US); Benny Soetarman, Fremont, CA (US)

(21) Appl. No.: 12/761,264

(22) Filed: Apr. 15, 2010

(51) Int. Cl. G06F 17/30

(52) U.S. Cl. 707/749; 707/E17.044

(57) ABSTRACT

A concept extraction machine accesses textual data of a document. The document comprises text and a title, and the textual data comprises the title and the text of the document. The concept extraction machine identifies a portion of the text as a text token. The concept extraction machine identifies the text token based on the portion of the text appearing in the emphasized text and in the title. The concept extraction machine further calculates a relevance value of the text token based on the textual data. The relevance value represents a probability that the text token is relevant to a concept expressed in the document. Based on the relevance value, the concept extraction machine stores the text token as concept metadata of the document. The concept extraction machine indexes the concept metadata and searches the concept metadata to identify the document in response to a search request.

### TECHNICAL FIELD

The subject matter disclosed herein generally relates to the processing of data. Specifically, the present disclosure addresses systems and methods of concept extraction using a title and emphasized text.

### BACKGROUND

Information in the form of text may be represented by textual data. “Text” refers to one or more symbols usable to convey or store the information according to a written language. Text may include, for example, alphabetic symbols (e.g., letters), numeric symbols (e.g., numerals), punctuation marks, logograms (e.g., ideograms), or any suitable combination thereof. Text may be included within a document to convey one or more concepts and may be of any length. As such, text may constitute a word, a phrase, a list, a sentence, a paragraph, chapter, or any combination thereof. Text may take the form of a unigram (e.g., a word, a number, an abbreviation, or an acronym), and multiple unigrams may be included in an n-gram (e.g., a phrase, a sentence, or a sequence of words).

“Textual data” refers to data that encodes a presentation of text (e.g., a document). As such, textual data may encode the text itself, a characteristic of the presentation of the text (e.g., layout, typeface, or emphasis), or both. Textual data may exist within a document (e.g., in a data file of the document), within metadata of the document (e.g., in a header or in a properties table), or external to the document (e.g., in a style sheet referenced by the data file of the document).

### BRIEF DESCRIPTION OF THE DRAWINGS

Some embodiments are illustrated by way of example and not limitation in the figures of the accompanying drawings in which:

FIG. 1 is an illustration of a graphical window displaying portions of text from a document, according to some example embodiments;

FIG. 2 is an illustration of textual data of the document, according to some example embodiments;

FIG. 3 is a network diagram of a system with a concept extraction machine, according to some example embodiments;

FIG. 4 is a block diagram illustrating modules of the concept extraction machine, according to some example embodiments;

FIG. 5 is a flow chart illustrating operations in a method of concept extraction using title and emphasized text, according to some example embodiments; and

FIG. 6 is a block diagram illustrating components of a machine, according to some example embodiments, able to read instructions from a machine-readable storage medium and perform any one or more of the methodologies discussed herein.

### DETAILED DESCRIPTION

Example methods and systems are directed to concept extraction using a title and emphasized text. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A concept extraction machine accesses textual data of a document. The document comprises text and a title, and the textual data includes the title of the document and the text of the document. The title of the document is indicated within the textual data by one or more title markers (e.g., a title tag), and the text of the document includes emphasized text indicated within the textual data by one or more emphasis markers (e.g., an emphasis tag).

The concept extraction machine identifies a portion of the text of the document as a text token. The text token may be an n-gram (e.g., a sequence of one or more unigrams). The concept extraction machine identifies the text token based on the portion of the text appearing in the emphasized text and in the title. For example, the phrase “ABC-100 camera” may appear in the title of the document, and the same phrase may appear in boldface elsewhere in the document. Based on these two appearances of the phrase, the concept extraction machine may identify “ABC-100 camera” as a text token (e.g., for further processing).

The concept extraction machine then calculates a relevance value of the text token with respect to the document. The relevance value is calculated by the concept extraction machine based on the textual data of the document. The relevance value represents a probability that the text token is relevant to one or more concepts expressed in the document. The concept extraction machine may determine that the relevance value transgresses a relevance threshold (e.g., exceeds a minimum relevance value) and, based on this determination, store the text token as concept metadata of the document. The concept metadata indicates a concept relevant to the document. The concept metadata, being metadata of the document, is indexable and searchable (e.g., by a search engine) and hence usable to identify the document during a conceptual search (e.g., a search for documents related to a concept).

In calculating the relevance value of the text token, the concept extraction machine may determine an occurrence count of the text token and calculate the relevance value based on the occurrence count. The concept extraction machine may also determine a maximum occurrence count of any text token in the document and calculate the relevance value based on the maximum occurrence count. For example, the relevance value may be calculated based on a ratio of the occurrence count of the text token to the maximum occurrence count of any text token in the document.

Moreover, the concept extraction machine may determine a textual distance (e.g., a number of lines of text, a number of paragraphs, or a number of words) between an appearance of the text token within the document and a determinable reference location (e.g., the top left corner of the document). The concept extraction machine may calculate the relevance value of the text token based on this textual distance. For example, a large textual distance (e.g., fifty paragraphs from the top of the document) may have the effect of reducing the relevance value calculated by the concept extraction machine, while a small textual distance (e.g., five lines from the top of the document) may have the effect of increasing the relevance value.

The concept extraction machine may implement a search engine configured to perform a conceptual search. As such, the concept extraction machine may index the concept metadata of the document and receive a search request from a client machine, where the search request includes one or more search terms that specify one or more concepts to be searched. Based on the search terms and the conceptual metadata of the document, the concept extraction machine may identify the document as a search result relevant to the search request. Accordingly, the concept extraction machine may provide the document to the client machine in response to the search request.

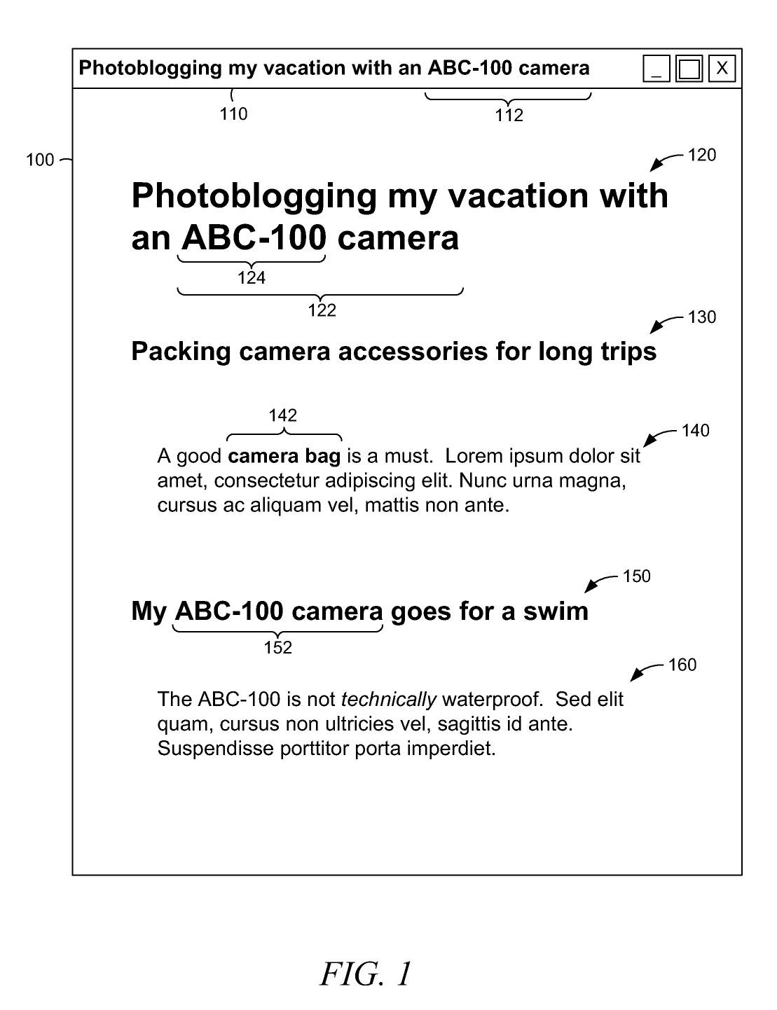

FIG. 1 is an illustration of a graphical window 100 displaying portions 120, 130, 140, 150, and 160 of text from a document, according to some example embodiments. The graphical window 100 includes a title bar 110 and the portions 120, 130, 140, 150, and 160 of text.

The title bar 110 displays a title of the document (e.g., “Photoblogging my vacation with an ABC-100 camera”). The title bar 110 comprises text and the text includes an appearance 112 of the phrase “ABC-100 camera.” Accordingly, the phrase “ABC 100 camera” constitutes a portion of the text in the title bar 110. As such, the phrase “ABC-100 camera” is identifiable as a text token occurring within the title of the document.

Within the graphical window 100, yet external to the title bar 110, a portion 120 of text includes the title of the document. The title is displayed in a strongly prominent typeface (e.g., compared to other typefaces in the document) and includes another appearance 122 of the phrase “ABC-100 camera.” Hence, the phrase “ABC 100 camera” is identifiable as a text token occurring within the document. Furthermore, the phrase “ABC-100 camera” may be identifiable as a text token occurring within the title of the document (e.g., as indicated by the strongly prominent typeface), within emphasized text of the document (e.g., as indicated by the prominent typeface, regardless of strength), or any suitable combination thereof.

As shown, a smaller phrase 124 “ABC-100” is included within the appearance 122 of the phrase “ABC-100 camera.” The smaller phrase 124 “ABC-100” is identifiable as a further text token; namely, a further text token occurring within another text token (e.g., the phrase “ABC-100 camera”).

Other portions 130, 140, 150, and 160 of text are displayed respectively in various typefaces. Two portions 130 and 150 are headings (e.g., section headings or chapter headings) within the document and are displayed using a moderately prominent typeface (e.g., compared to other typefaces in the document). As headings, the portions 130 and 150 constitute emphasized text within the document. A portion 150 of text includes further appearance 152 of the phrase “ABC-100 camera,” which is identifiable as a text token occurring within the document.

Two other portions 140 and 160 are paragraphs (e.g., normal text or body text) within the document and are displayed using a non-emphasized typeface (e.g., compared to other typefaces within the document), with the exception of a phrase 142 “camera bag” appearing in one portion 140 of the text. The phrase 142 “camera bag” is displayed within the portion 140 using an emphasized typeface (e.g., compared to the typeface used for normal text in the document). For example, the phrase 142 may be displayed in a bold typeface, an italic typeface, a flashing typeface, a typeface of a particular color, or any suitable combination thereof. Accordingly, the phrase 142 also constitutes emphasized text within the document.

The graphical window 100 displays the portions 120, 130, 140, 150, and 160 of text using a particular layout, which may be specified by one or more markers (e.g., tags) in textual data of the document. As such, the graphical window 100 may display at least a portion of the document (e.g., portions 120, 130, 140, 150, and 160) in a manner suitable for easy reading by a human.

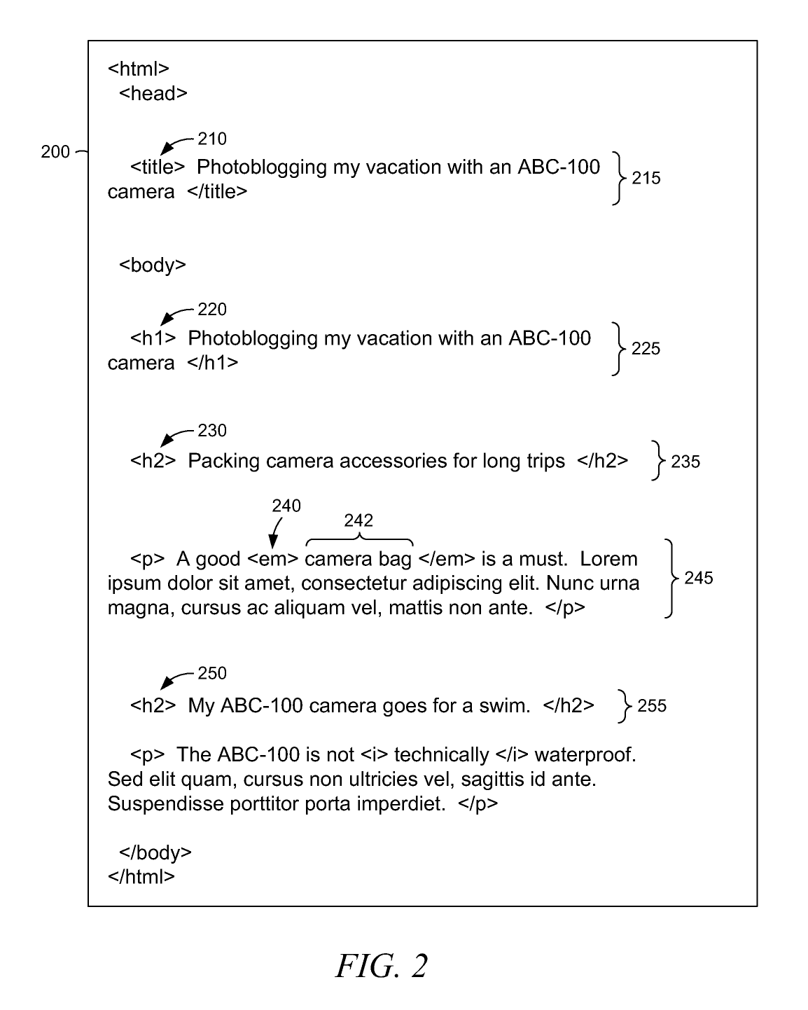

FIG. 2 is an illustration of the textual data 200 of the document displayed in the graphical window 100, according to some example embodiments. The textual data 200 includes portions 215, 225, 235, 245, and 255 of the textual data 200. As shown, the textual data 200 includes text displayed in the graphical window 100 (e.g., portions 120, 130, 140, 150, and 160) and markers that specify presentation characteristics of the document.

The portion 215 of the textual data 200 includes the title of the document (e.g., “Photoblogging my vacation with an ABC-100 camera”). The portion 215 further includes a title marker 210 that identifies this as the title of the document. The title marker 210 indicates that the phrase “Photoblogging my vacation with an ABC 100 camera” is to be displayed in the title bar 110 of the graphical window 100.

Another portion 225 of the textual data 200 also includes the title of the document (e.g., “Photoblogging my vacation with an ABC 100 camera”), which appears in a portion 120 of text displayed in the graphical window 100. The portion 225 further includes a title marker 220. The title marker 220 indicates a particular text format. For example, as shown, the title marker 220 indicates that the phrase “Photoblogging my vacation with an ABC 100 camera” is to be displayed as a heading (e.g., a top level heading illustrated as “<h1>”) in the graphical window 100.

Yet another portion 235 of the textual data 200 includes the text appearing in the portion 130 of text displayed in the graphical window 100 (e.g., “Packing camera accessories for long trips”). The portion 235 of the textual data 200 also includes an emphasis marker 230. The emphasis marker 230 indicates a particular text format. For example, as shown, the emphasis marker 230 indicates that the text of the portion 235 is to be displayed as a heading (e.g., a second-level heading illustrated as “<h2>”) in the graphical window 100.

A further portion 245 of the textual data 200 includes the text appearing in the portion 140 of text displayed in the graphical window 100 (e.g., “A good camera bag is a must.”). The portion 245 of the textual data 200 also includes an emphasis marker 240. The emphasis marker 240 indicates a particular text format. For example, as shown, the emphasis marker 240 indicates that a phrase 242 (e.g., “camera bag”) is to be displayed as emphasized text (e.g., boldface text illustrated as “<em>”) in the graphical window 100.

A still further portion 255 of the textual data 100 includes the text appearing in the portion 150 of text displayed in the graphical window 100 (e.g., “My ABC-100 camera goes for swim”). The portion 255 of the textual data 200 also includes an emphasis marker 250. The emphasis marker 250 indicates that the text of the portion 255 is to be displayed as a heading (e.g., the second-level heading) in the graphical window 100.

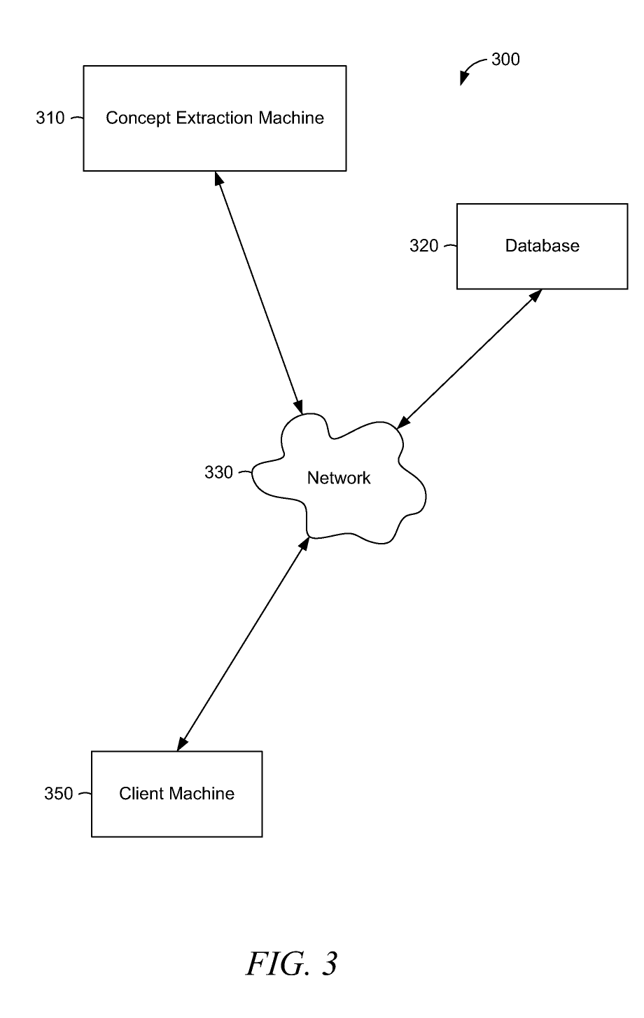

FIG. 3 is a network diagram of a system 300 with a concept extraction machine 310, according to some example embodiments. The system 300 includes the concept extraction machine 310, a database 320 (e.g., a database server machine), and a client machine 350 (e.g., a personal computer or a mobile phone), all coupled to each other via a network 330.

The concept extraction machine 310 is configured to access the database 320 via the network 330. The database 320 stores the textual data 200 of the document, and the database 320 may be a repository to store multiple documents, with each document being respectively stored as a file of textual data (e.g., textual data 200). The database 320 may be embodied in (e.g., served from) a database server machine connected to the network 330.

The concept extraction machine 310 is also configured to communicate with the client machine 350. For example, the concept extraction machine 310 may receive a search request from the client machine 350, and the concept extraction machine 310 may provide some or all of the textual data 200 to the client machine 350 for display at the client machine 350 (e.g., using the graphical window 100).

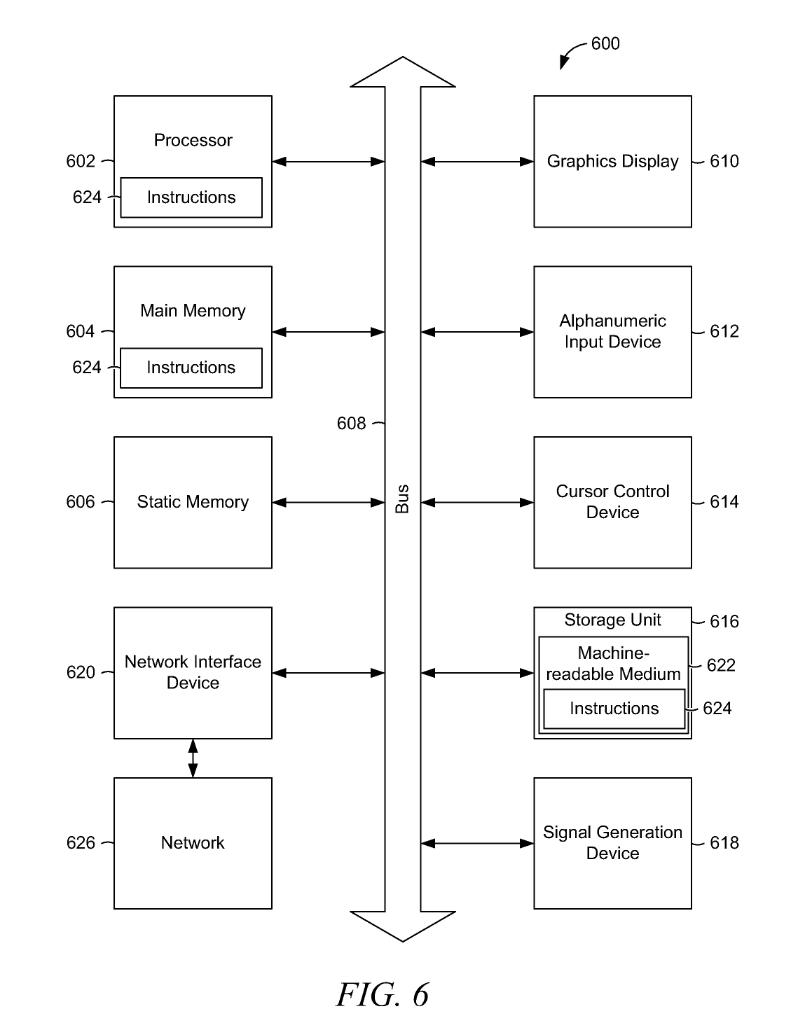

Any of the machines shown in FIG. 3 may be implemented in a general-purpose computer modified (e.g., programmed) by software to be a special-purpose computer to perform the functions described herein for that machine. For example, a computer system able to implement any one or more of the methodologies described herein is discussed below with respect to FIG. 6. Moreover, any two or more of the machines illustrated in FIG. 3 may be combined into a single machine, and the functions described herein for any single machine may be subdivided among multiple machines.

The network 330 may be any network that enables communication between machines (e.g., the concept extraction machine 310 and the client machine 350). Accordingly, the network 330 may be a wired network, a wireless network, or any suitable combination thereof. The network 330 may include one or more portions that constitute a private network, a public network (e.g., the Internet), or any suitable combination thereof.

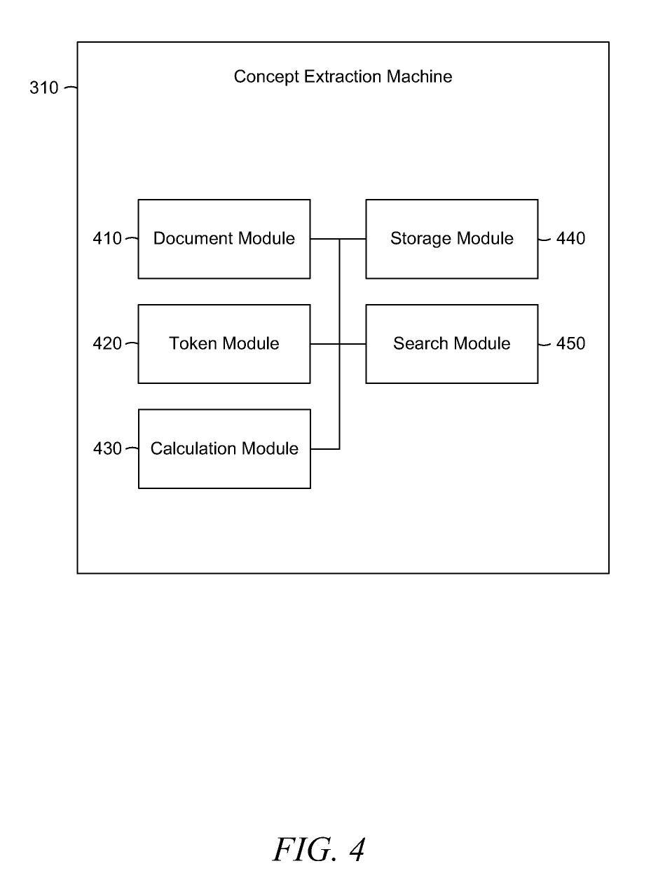

FIG. 4 is a block diagram illustrating modules of the concept extraction machine 310, according to some example embodiments. The concept extraction machine 310 includes a document module 410, a token module 420, a calculation module 430, a storage module 440, and a search module 450, all configured to communicate with each other (e.g., via a bus, a shared memory, or a switch). Any of these modules may be implemented using hardware or a combination of hardware and software. Moreover, any two or more of these modules may be combined into a single module, and the functions described herein for a single module may be subdivided among multiple modules.

The document module 410 is configured to access textual data (e.g., textual data 200) of a document. As noted above, the textual data includes text of the document and includes a title of the document (e.g., “Photoblogging my vacation with an ABC-100 camera”). The text of the document includes emphasized text (e.g., the phrase 142 “camera bag”), which is indicated within the textual data by an emphasis marker (e.g., the emphasis marker 240 “<em>”). The title of the document is indicated within the textual data by a title marker (e.g., the title marker 210 “<title>”). The document module 410, for example, may access the textual data by reading the textual data from the database 320. As another example, the document module 410 may receive the textual data via the network 330 (e.g., from the client machine 350).

In accessing the textual data (e.g., textual data 200) of the document, the document module 410 may access a style sheet of the document and parse the data of the style sheet to identify the emphasized text. For example, a portion of the textual data may be contained in a Cascading Style Sheet (CSS) file that stores one or more presentation characteristics for multiple documents, including the document being processed by the concept extraction machine 310. The document module 410 may, accordingly, access CSS data and parse the CSS data to identify the emphasized text of the document.

The token module 420 is configured to identify one or more text tokens occurring in the text of the document, based on the textual data (e.g., textual data 200) accessed by the document module 410. Specifically, the token module 420 identifies a portion of the text of the document as a text token, based on the portion of the text appearing in the emphasized text and in the title of the document. In particular, the token module 420 may identify the portion of the text as the text token based on one or more markup language tags included in the textual data. For example, with reference to FIG. 1, the phrase “ABC-100 camera” is a portion of the document that appears in the title of the document (e.g., appearances 112 and 122) and also appears in emphasized text of the document (e.g., appearance 152). As shown in FIG. 2, the title marker 210 and the emphasis marker 250 are markup language tags. Accordingly, based on these appearances, the token module 420 may identify the phrase “ABC-100 camera” as a text token that appears in both the title and in emphasized text of the document. As indicated above, a text token may be a phrase of any length and may include one or more smaller text tokens.

Also, the token module 420 may identify the portion of the text based on a non-alphanumeric and non-blank character included in the textual data (e.g., textual data 200). For example, the token module 420 may identify a hyphen as a boundary between two text tokens (e.g., “ABC” and “100” as being two text tokens within “ABC-100”). Other examples of non-alphanumeric and non-blank characters include, but are not limited to, an underscore character, an equals sign, a dash, a period, a comma, an at symbol (e.g., @), a copyright sign (e.g., ©), a trademark sign (e.g., ™), or any suitable combination thereof. The token module 420 may identify one or more punctuation marks that indicate a sentence boundary within the textual data (e.g., a period followed by one or more spaces, followed by a capital letter), and the token module 420 may identify the portion of the text based on the sentence boundary.

The calculation module 430 is configured to calculate a relevance value of the text token (e.g., “ABC-100 camera”) with respect to the document. This relevance value is calculated by the calculation module 430 based on the textual data (e.g., textual data 200) of the document.

Moreover, the calculation module 430 may access a format weighting parameter (e.g., stored in the database 320) and calculate the relevance value based on the format weighting parameter. The format weighting parameter corresponds to a text format used to display an appearance (e.g., appearance 122) of the text token. For example, the calculation module 430 may accord greater weight to a text token occurring in a top-level heading (e.g., indicated by “<h1>”) than a text token occurring in a second-level heading (e.g., indicated by “<h2>”). As another example, the calculation module 430 may accord more weight to an appearance of the text token in any heading than an appearance in normal text, even if emphasized.

Furthermore, the calculation module 430 may determine a textual distance based on the textual data (e.g., textual data 200) of the document. The textual distance is a distance from a determinable reference location within the document to an appearance (e.g., appearance 122) of the text token within the document. As noted above, the determinable reference location may be a particular position within the document (e.g., top left corner, beginning of text, or a heading). Hence, the textual distance may be expressed as a number of lines of text, a number of paragraphs of text, a number of pages of the document, a number of words, or any suitable combination thereof. The calculation module 430 may calculate the relevance value of the text token based on this textual distance. As an example, a large textual distance may imply less relevance and hence have the effect of reducing the relevance value calculated by the calculation module 430. As another example, a small textual distance may imply more relevance and hence have the effect of increasing the relevance value calculated by the calculation module 430.

Additionally, the calculation module 430 may determine an occurrence count of the text token. The occurrence count indicates a number of occurrences of the text token within the document (e.g., seven occurrences of the text token “ABC-100”). The calculation module 430 may also determine a maximum occurrence count of any text token within the document (e.g., thirty-five occurrences of the text token “camera”). The ratio of the occurrence count to the maximum occurrence count may be calculated by the calculation module 430 (e.g., the occurrence count divided by the maximum occurrence count), and the calculation module 430 may calculate the relevance value of the text token based on this ratio.

The storage module 440 is configured to determine whether the relevance value calculated by the calculation module 430 transgresses a relevance threshold (e.g., exceeds a minimum relevance value). Based on this determination, the storage module 440 may store the text token (e.g., “ABC-100 camera”) as concept metadata of the document. The concept metadata indicates that the text token is conceptually relevant to the document (e.g., that “ABC-100 camera” is a concept relevant to the document). For example, the database 320 may store the textual data (e.g., textual data 200) of the document, and the storage module 440 may store the text token in a metadata file that corresponds to the textual data of the document.

The search module 450 is configured to index the concept metadata of the document, receive a search request from the client machine 350, identify the document based on the concept metadata, and provide the document to the client machine 350. In indexing the concept metadata, the search module 450 may compile an index of multiple documents with similar or identical concept metadata. The search request is a query for documents relevant to one or more search terms (e.g., conceptual search terms). The client machine 350 may transmit the search request to the concept extraction machine 310 for processing by the search module 450. The search module 450 compares the one or more search terms to the concept metadata of the document and identifies the document in response to the search request.

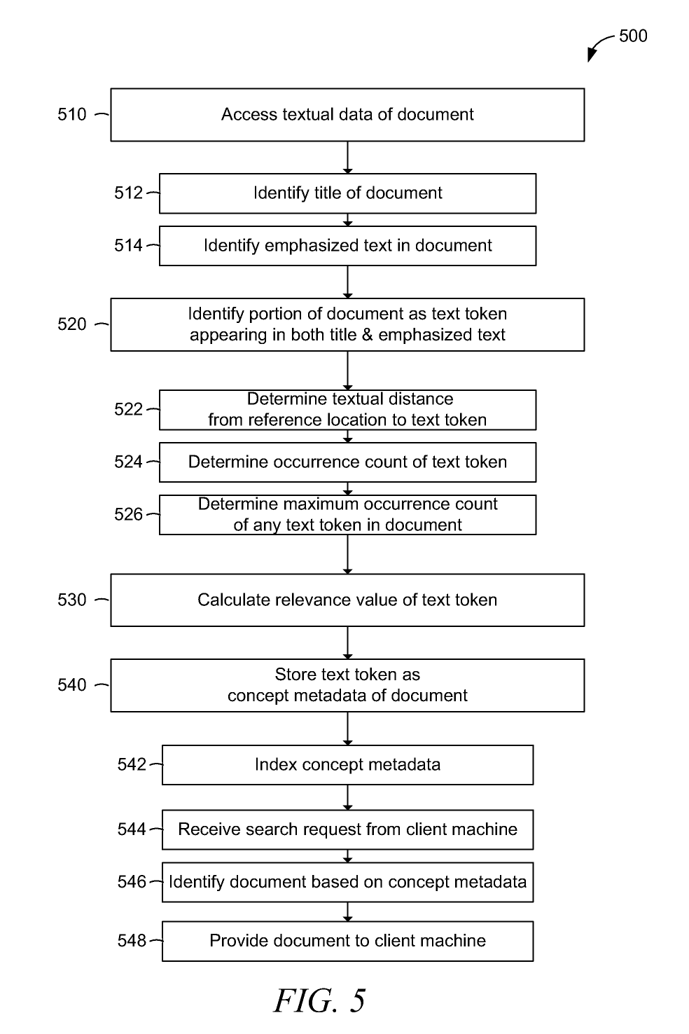

FIG. 5 is a flow chart illustrating operations 510-548 in a method 500 of concept extraction using a title and emphasized text, according to some example embodiments. The method 500 may be performed by one or more modules of the concept extraction machine 310.

In operation 510, the document module 410 of the concept extraction machine 310 accesses textual data (e.g., textual data 200) of a document, which may be stored on the database 320. As noted above, the accessing of the textual data may include reading the textual data from the database 320, receiving the textual data via the network 330, accessing a style sheet (e.g., CSS data), or any suitable combination thereof. Hence, the textual data may be accessed in multiple portions from multiple sources.

The token module 420 of the concept extraction machine 310 may perform operations 512-520. In operation 512, the token module 420 identifies the title of the document. This identification may be made based on one or more markup language tags occurring within the textual data (e.g., textual data 200) of the document. For example, the identification may be made based on one or more title markers (e.g., title marker 210) appearing in the textual data.

In operation 514, the token module 420 identifies emphasized text in the document. The identification of the emphasized text may be made based on one or more markup language tags occurring within the textual data. As an example, identification of emphasized text may be made based on one or more emphasis markers (e.g., emphasis markers 220, 230, 240, and 250) appearing in the textual data.

In operation 520, the token module 420 identifies a portion of the document (e.g., portion of the text of the document) as a text token that appears in the title of the document and in emphasized text of the document. The identification of the portion is based on the textual data (e.g., textual data 200), including any markup language tags (e.g., title marker 210 or emphasis marker 240) appearing in the textual data.

The calculation module 430 of the concept extraction machine 310 may perform operations 522-530. In operation 522, the calculation module 430 determines a textual distance from a reference location (e.g., a determinable reference location) to an appearance of the text token (e.g., appearance 152 of the phrase “ABC-100 camera”). Where a text token appears multiple times within a document, multiple textual distances may be calculated by the calculation module 430. The calculation module 430 may use one or more of these textual distances to calculate a relevance value of the text token. For example, the calculation module 430 may base the relevance value on the shortest textual distance, the longest textual distance, an average textual distance (e.g., a weighted average textual distance), or any suitable combination thereof.

In operation 524, the calculation module 430 determines an occurrence count of the text token. For example, the calculation module 430 may determine that the text token (e.g., the phrase “ABC-100”) occurs seven times in the document (e.g., in the textual data of the document). In operation 526, the calculation module 430 determines a maximum occurrence count of any text token in the document (e.g., as identified by the token module 420). For example, the calculation module 430 may determine that another text token (e.g., the phrase “camera”) occurs thirty-five times in the document. The calculation module 430 may use the occurrence count of the text token to calculate the relevance value of the text token. As an example, the calculation module may calculate a ratio of the occurrence count to the maximum occurrence count and thereafter calculate the relevance value based on the ratio.

In operation 530, the calculation module 430 calculates a relevance value of the text token. As noted above, the calculation module 430 may access a format weighting parameter and calculate the relevance value based on the format weighting parameter. Moreover, the calculation module 430 may calculate the relevance value based on the textual distance between a reference location within the document to an appearance (e.g., appearance 152) of the text token within the document. Furthermore, the calculation module 430 may calculate the relevance value based on the occurrence count of the text token, a maximum occurrence count of any text token in the document, or any suitable combination thereof.

Operation 540 may be performed by the storage module 440 of the concept extraction machine 310. In operation 540, the storage module 440 determines whether the relevance value of the text token transgresses a relevance threshold. For example, the storage module 440 may determine that the relevance value exceeds a minimum relevance value (e.g., predetermined and stored at the concept extraction machine 310). Based on this determination, the storage module 440 stores the text token (e.g., “ABC-100 camera”) as concept metadata of the document. As noted above, the concept metadata indicates that the text token is conception relevant to the document. The storage module 440 may store the concept metadata of the document in the database 320 for indexing and subsequent searching by the search module 450.

Operations 542-548 may be performed by the search module 450 of the concept extraction machine 310. In operation 542, the search module 450 indexes the concept metadata stored by the storage module 440. The search module 450 may index the concept metadata as part of a batch processing operation that indexes the concept metadata of multiple documents stored on the database 320.

In operation 544, the search module 450 receives a search request from the client machine 350. As noted above, the search request includes one or more search terms that may specify a conceptual query for documents with concepts that are relevant to the search terms. A search request may be submitted by a user of the client machine 350. The user may be a human user or a machine user (e.g., web crawler software operating on the client machine 350).

In operation 546, the search module 450 identifies the document based on the concept metadata. The search module 450 may compare the one or more search terms to the concept metadata of the document and determine that the concept metadata matches a search term. Based on this determination, the search module 450 may identify the document as a conceptual match to the search request.

In operation 548, the search module 450 provides the document to the client machine 350 in response to the search request. For example, the search module 450 may transmit the document in the form of its textual data (e.g., textual data 200) to the client machine 350 for display at the client machine 350 (e.g., using a graphical window 100). The client machine 350 may display the document to a user of the client machine 350.

According to various example embodiments, one or more of the methodologies described herein may facilitate identification and provision of relevant documents in response to a search request (e.g., a conceptual search request). Moreover, extraction and storage of context metadata may facilitate automatic (e.g., performed by machine) generation of summary information with respect to one or more documents. For example, a library of documents may be labeled (e.g., tagged) with conceptually relevant words or phrases, using one or more of the methodologies described herein. Accordingly, one or more of the methodologies discussed herein may facilitate automated information processing of human-generated documents, thus obviating or reducing a need for human review of such documents to identify relevant concepts expressed in the document. Furthermore, by facilitating identification and provision of relevant documents in response to a search request, one or more of the methodologies described herein may obviate or reduce the need for extensive searching (e.g., by keywords), which may have the technical effect of reducing computing resources used by search engines and client devices (e.g., client machine 350). Examples of such computing resources include, without limitation, processor cycles, network traffic, memory usage, storage space, and power consumption.

FIG. 6 illustrates components of a machine 600, according to some example embodiments, that is able to read instructions from a machine-readable medium (e.g., machine-readable storage medium) and perform any one or more of the methodologies discussed herein. Specifically, FIG. 6 shows a diagrammatic representation of the machine 600 in the example form of a computer system and within which instructions 624 (e.g., software) for causing the machine 600 to perform any one or more of the methodologies discussed herein may be executed. In alternative embodiments, the machine 600 operates as a standalone device or may be connected (e.g., networked) to other machines. In a networked deployment, the machine 600 may operate in the capacity of a server machine or a client machine in a server-client network environment, or as a peer machine in a peer-to-peer (or distributed) network environment. The machine 600 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 624 (sequentially or otherwise) that specify actions to be taken by that machine. Further, while only a single machine is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The machine 600 may further include a graphics display 610 (e.g., a plasma display panel (PDP), a liquid crystal display (LCD), a projector, or a cathode ray tube (CRT)). The machine 600 may also include an alphanumeric input device 612 (e.g., a keyboard), a cursor control device 614 (e.g., a mouse, a touchpad, a trackball, a joystick, a motion sensor, or other pointing instrument), a storage unit 616, a signal generation device 618 (e.g., a speaker), and a network interface device 620.

The storage unit 616 includes a machine-readable medium 622 on which is stored the instructions 624 (e.g., software) embodying any one or more of the methodologies or functions described herein. The instructions 624 may also reside, completely or at least partially, within the main memory 604, within the processor 602 (e.g., within the processor's cache memory), or both, during execution thereof by the machine 600. Accordingly, the main memory 604 and the processor 602 may be considered as machine-readable media. The instructions 624 may be transmitted or received over a network 626 (e.g., network 330) via the network interface device 620.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 622 is shown in an example embodiment to be a single medium, the term “machine-readable medium” should be taken to include a single medium or multiple media (e.g., a centralized or distributed database, or associated caches and servers) able to store instructions (e.g., instructions 624). The term “machine-readable medium” shall also be taken to include any medium that is capable of storing instructions (e.g., software) for execution by the machine, such that the instructions, when executed by one or more processors of the machine (e.g., processor 602), cause the machine to perform any one or more of the methodologies described herein. The term “machine-readable medium” shall accordingly be taken to include, but not be limited to, a data repository in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A computer-implemented method comprising:
accessing textual data of a document, the textual data including text of the document and including a title of the document, the text of the document including emphasized text indicated within the textual data by an emphasis marker, the title being indicated within the textual data by a title marker;
identifying a portion of the text of the document as a text token based on the portion of the text appearing in the emphasized text and in the title, the identifying being performed by a module implemented using a processor of a machine;
calculating a relevance value of the text token with respect to the document, the relevance value being calculated based on the textual data of the document; and
storing the text token as concept metadata of the document, the concept metadata being indicative of a concept relevant to the document.

2. The computer-implemented method of claim 1, wherein:
the emphasis marker is indicative of a text format;
the calculating of the relevance value is based on a format weighting parameter that corresponds to the text format; and the method further comprises
accessing the format weighting parameter.

3. The computer-implemented method of claim 1, wherein:
the textual data includes Cascading Style Sheet (CSS) data; and the method further comprises
identifying the emphasized text by parsing the CSS data.

4. The computer-implemented method of claim 1, wherein:
the storing of the text token as concept metadata of the document is based on a determination that the relevance value transgresses a relevance threshold.

5. The computer-implemented method of claim 1 further comprising:
determining a textual distance from a determinable reference location within the document to an appearance of the text token within the document; and wherein
the calculating of the relevance value is based on the textual distance.

6. The computer-implemented method of claim 1 further comprising:
determining an occurrence count of the text token, the occurrence count indicating a number of occurrences of the text token within the document.

7. The computer-implemented method of claim 6, wherein:
the calculating of the relevance value includes dividing the occurrence count by a further occurrence count that indicates a maximum number of occurrences of any text token within the document.

8. The computer-implemented method of claim 6, wherein:
the text token is a first text token that includes a second text token identified based on the textual data; and
the calculating of the relevance value is based on the occurrence count and on a further occurrence count that indicates a number of occurrences of the second text token within the document.

9. The computer-implemented method of claim 1, wherein:
the identifying of the portion of the text of the document as the text token is based on a markup language tag included in the textual data.

10. The computer-implemented method of claim 1, wherein:
the identifying of the portion of the text of the document as the text token is based on a non-alphanumeric and non-blank character included in the textual data.

11. The computer-implemented method of claim 10, wherein:
the non-alphanumeric and non-blank character indicates a sentence boundary within the document.

12. The computer-implemented method of claim 1, wherein:
the text token is a first text token that includes a second text token;
the first text token is an n-gram including a plurality of unigrams; and
the second text token is a unigram of the plurality of unigrams.

13. The computer-implemented method of claim 12, wherein:
the first text token is a phrase including a plurality of words; and
the second text token is a word of the plurality of words.

14. The computer-implemented method of claim 1 further comprising:
identifying the document based on the concept metadata; wherein
the identifying of the document is responsive to a request to search for documents relevant to the concept.

15. A system comprising:
a document module configured to access textual data of a document, the textual data including text of the document and including a title of the document, the text of the document including emphasized text indicated within the textual data by an emphasis marker, the title being indicated within the textual data by a title marker;
a hardware-implemented token module configured to identify a portion of the text of the document as a text token based on the portion of the text of the document appearing in the emphasized text and in the title;
a calculation module configured to calculate a relevance value of the text token with respect to the document, the relevance value being calculated based on the textual data of the document; and
a storage module configured to store the text token as concept metadata of the document, the concept metadata being indicative of a concept relevant to the document.

16. The system of claim 15, wherein:
the emphasis marker is indicative of a text format; and
the calculation module is configured to:
access a format weighting parameter that corresponds to the text format; and
calculate the relevance value based on the format weighting parameter.

17. The system of claim 15, wherein:
the calculation module is configured to:
determine a textual distance from a determinable reference location within the document to an appearance of the text token within the document; and
calculate the relevance value based on the textual distance.

18. The system of claim 15, wherein:
the text token is a first text token that includes a second text token identified based on the textual data; and
the calculation module is configured to:
determine an occurrence count of the first text token, the occurrence count indicating a number of occurrences of the first text token within the document; and
calculate the relevance value based on the occurrence count and on a further occurrence count that indicates a number of occurrences of the second text token within the document.

19. The system of claim 15 further comprising:
a search module configured to identify the document based on the concept metadata in response to a request to search for documents relevant to the concept.

20. A machine-readable storage medium comprising instructions that, when executed by one or more processors of a machine, cause the machine to perform a method comprising:
accessing textual data of a document, the textual data including text of the document and including a title of the document, the text of the document including emphasized text indicated within the textual data by an emphasis marker, the title being indicated within the textual data by a title marker;
identifying a portion of the text of the document as a text token based on the portion of the text of the document appearing in the emphasized text and in the title;
calculating a relevance value of the text token with respect to the document, the relevance value being calculated based on the textual data of the document; and
storing the text token as concept metadata of the document, the concept metadata being indicative of a concept relevant to the document.
